(19) United States
(12) Patent Application Publication
(10) Pub. No.: US 2007/0185807 A1
(43) Pub. Date: Aug. 9, 2007

(54) System and method for online auction

(75) Inventor: Phuoc-Chau Nguyen, San Jose, CA (US)

Correspondence Address: MACPHERSON KWOK CHEN & HEID LLP, 2033 GATEWAY PLACE, SUITE 400, SAN JOSE, CA, 95110, US

(73) Assignee: YasfA, Inc.

(21) Appl. No.: 11/348,832

(22) Filed: Feb. 6, 2006

(51) Int. Cl. G06Q 40/00

(52) U.S. Cl. 705/39

(57) ABSTRACT

A method for on-line commercial transactions (i.e., “electronic commerce” or “e-commerce”) creates a community in which the on-line commercial transactions are conducted among registered members. In one embodiment, a new member may be referred by an existing member, and the existing member's account is credited an amount which equals a predetermined percentage of the value of each on-line commercial transaction brought by the new member. After a predetermined time has elapsed, the existing member may cash out his credited earnings, donate the earnings to his designated charity, or instruction disposition by a combination of both. The on-line commercial transaction may be, for example, an on-line auction.

### BACKGROUND OF THE INVENTION

1. Field of the Invention

The present invention relates to electronic commercial (“e-commerce”) activities. In particular, the present invention relates to conducting online auctions in a community of registered individual members.

2. Discussion of the Related Art

Online auction can be an effective medium for individuals to trade merchandise on a small scale. However, the online auction sites on the internet today have evolved into marketplaces that provide advantages primarily to dealers or institutional sellers. The fee structure charged by companies hosting the auctions, for example, discriminates against individual sellers who do not conduct a large number of auctions. Further, because these online auction sites accept bids from automatic bidding systems, unsophisticated buyers are often at a distinct disadvantage relative to these automated bidders.

There is therefore a need for an online auction system that does not favor institutional sellers.

### SUMMARY

The present invention provides a method for conducting on-line commercial transactions (i.e., “electronic commerce” or “e-commerce”). According to one embodiment of the present invention, the method creates a community in which the on-line commercial transactions are conducted only among registered members. In that embodiment, a new member may be sponsored or introduced by an existing member. To encourage introduction, the existing member's account is credited an amount which equals a predetermined percentage of the value of any on-line commercial transaction that is brought by the new member. After a predetermined time has elapsed the existing member may cash out the amount accumulated from transactions attributed to the members the existing member introduced, donate that amount to his designated charity or charities, or a combination of both. In one embodiment, the on-line commercial transactions are an on-line auctions.

According to one embodiment of the present invention, the rules for on-line commercial transactions conducted in the community are designed to be not favoring dealers or institutional participants at the expense of individual participants. To that end, an on-line auction conducted under a system of the present invention minimizes bids originating from an automatic bidding system by prohibiting setting of a reserve price. To further discourage automatic bids, the on-line auction allows bidding any amount over an existing bid, and the on-line auction terminates based on a time measured from when a first bid is submitted.

According to one embodiment of the present invention, the on-line commercial transaction may be conducted over a cellular telephone.

According to one embodiment of the present invention, each member proves his/her credit-worthiness by providing, at the time of registration, information necessary to authorize charging a commercial transaction to his/her credit card. In that embodiment, each member is asked upon registration to designate a default charity to which the member's earning are to be donated, if no contrary disposition instruction is received from the member at a subsequent time. To encourage participation, a member's earnings may be forfeited to his default charity, unless he/she participates as a principal in an on-line commercial transaction over a given accounting period. A member may be rewarded when the on-line commercial transactions attributable to the member, or in which the member has participated, are valued at an amount exceeding a predetermined value. Rewards may be sponsored by an advertiser.

The present invention is better understood upon consideration of the detailed description below and the accompanying drawings.

### BRIEF DESCRIPTION OF THE DRAWINGS

FIG. 1 illustrates the rules for each member on on-line auction system 100, according to one embodiment of the present invention.

### DETAILED DESCRIPTION OF THE PREFERRED EMBODIMENTS

The present invention provides an on-line auction system in which all the participants are registered members of the system. The system encourages an existing member to refer others to become members in the on-line auction system by awarding a small percentage of the values of the transactions conducted by the members referred by the existing member over an accounting period (e.g., one year). At the end of the accounting period, the awarded amount is either sent to charitable causes or paid out as an incentive to the sponsoring member.

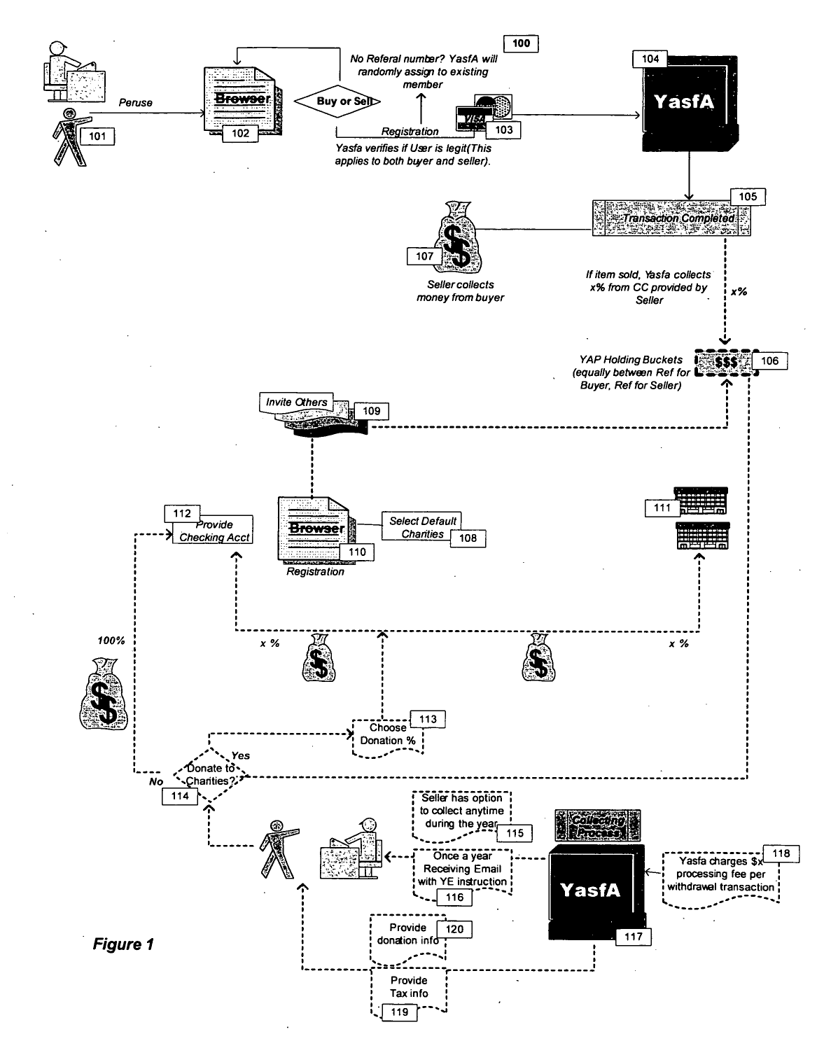

FIG. 1 illustrates the rules for each member on on-line auction system 100, according to one embodiment of the present invention. On-line auction system 100 provides an auction website on the internet that can be accessed using a conventional web browser (e.g., Microsoft Internet Explorer), from a mini-browser or another messaging tool that has become more prevalent in portable devices and cellular telephones. As shown in FIG. 1, although any listing on the auction website (102) can be perused by anyone, before a user can participate in any auction on the website, whether as a seller or as a bidder, the user must become a registered member of the website. As indicated at step 103, to ensure that only credit-worthy members can participate in the auctions, the user seeking registration is asked to provide a valid credit card as part of the qualification process. Once the user is registered, the user can bid in any auction on the website, or post a new auction listing as a seller (104).

When a new member is not referred by an existing member, the system randomly assigns the new member to an existing member. This arrangement allows existing members to further benefit from increase in the membership.

To encourage members to introduce the website to others, a member who refers another member receives an incentive whenever the sponsored member successfully purchased or sold a merchandise or a service on the website. According to one embodiment of the present invention, when a listing is successfully completed, the seller member and the buyer member settle the transaction among themselves, i.e., the seller member and the buyer member make their own arrangement for payment and product shipment. After a period of n (e.g. 7) business days, the system will collect x % (e.g., 2%) from the seller member's authorized bank account or credit card, according to the seller member's instructions. In this embodiment, x % (e.g., 2%) of the sale price is divided equally and credited to accounts 106 (“buckets”) of the members who referred the buyer and the seller to the system. In this embodiment, this reward system is one-tier—i.e., no reward is given to the referring member's sponsor. If a member is introduced to the system through referrals by more than one existing member, the member selects one of the referring members (represented by a “referral number”) to receive the credit. Priority can be easily resolved, for example, by the system issuing referral numbers that the referring members may send to potential new members, with the referral numbers each being issued with a non-decreasing reference number.

Members can issue invitations or transact business using a conventional web browser (110), or another suitable tool (e.g, a mini-web browser running on a cellular phone). For example, a member can issue invitations (109) to others or to name one or more default charities (108) to benefit from the money accumulating in the member's bucket. In one embodiment, the portion of the member's holding account or bucket can be withdrawn (114) at any time (115) to a member's bank account (112), one or more designated charities (111), or a combination of withdrawal and charitable donations, at the member's discretion (113). The reward money (i.e., the allocated percentage from transactions made by members introduced by the member) accumulating in a member's bucket is disbursed annually, e.g., on the anniversary of the member's registration (116). A complete disbursement every year is desirable, as it limits the total amount accumulating in the member's bucket. A courtesy notice (114) is sent to the member prior to the anniversary, to allow the member time to instruct the system regarding the manner of disposition. The member may specify donating all, none or part of the money to one or more designated charities (114). If a member does not provide instructions prior to the anniversary date, the money in the member's bucket is donated equally to the charities the member has named as default.

To encourage participation by all members, according to one embodiment of the present invention, a member who has not at least transacted once using the system during the preceding accounting period is not entitled to disburse from his bucket to his bank account. All proceeds from the member's bucket would then be donated to the member's default charities. In addition, addition incentives may be awarded a member when the number of times the member participated in activities of the website reaches a predetermined number. The threshold may also be set at a target total dollar volume of the member's purchases or sales, for example. Of course, the system may also provide rewards to members by random selection. Rewards and prizes can be financed or sponsored by advertising partners. For example, an airline may sponsor a vacation package to reward a member who is attributed a total sale amount (i.e., the total of the sales in his listings, the purchases he made, and the total sales by members he introduced) that reaches a predetermined goal.

To cover the cost of accounting, the system may charge a fee for each withdrawal or disbursement (118). The system keeps track of all financial transactions (117) into and out of the member's account. At the beginning of each year, the member is provided information regarding his withdrawals and disbursements (118) and information regarding his charitable donations through the system (120) for the preceding year.

In order to tailor the online auctions conducted in the system to the expectations of the individual members, and not to favor institutional sellers, the rules governing the on-line auctions carried out under the present invention are often different from those typically found in a conventional on-line auction site. For example, according to one embodiment of the present invention, each listing has a fixed life time. Alternatively, in that embodiment, after a first bid is submitted in a listing, the bidding will last for a fixed number of days measured from the time of the first bid, or for the remainder of the fixed life time, whichever is earlier. To ensure that all members are treated equally and sophisticated members are not given an unfair advantage, the system does not entertain automatic bids. (Automatic bids may be screened out, for example, by requiring a bidder to repeat a code word that is generated and displayed on the bid web page; such a code word is preferable generated in a graphical form that is difficult for a machine to capture.) Automated bidding can be deterred also by allowing a member to bid in any amount in excess of a minimum increment over a current highest bid on an item. For example, if the minimum increment bid for an item is $1, a bidder for an item currently with an existing highest bid of $12 may bid $75. In this system, the prevailing bid would go immediately to $75, rather than at $13, as is the practice of many prior on-line auction websites. Such a rule would obviate any perceived advantage of using a last-minute automatic bidding programs.

The above detailed description is provided to illustrate the specific embodiments of the present invention, and is not intended to be limiting. Numerous variations and modifications within the scope of the present invention are possible. The present invention is set forth in the following claims.

I claim:

1. A method for creating a community based on on-line commercial transactions, comprising:
registering a new member who is introduced to the community by an existing member;
conducting an on-line commercial transaction as to which the new member is a principal;
crediting to an account assigned to the existing member an amount which equals a predetermined percentage of a valuation of the on-line commercial transaction;
after a predetermined time, allowing the existing member to transfer a portion of the amount to a charity designated by the existing member.

2. A method as in claim 1, wherein the on-line commercial transaction is an on-line auction.

3. A method as in claim 2, wherein the on-line auction minimizes bids originating from an automatic bidding system.

4. A method as in claim 2, wherein the on-line auction prohibits setting of a reserve price.

5. A method as in claim 2, wherein the on-line auction allows bidding any amount over an existing bid.

6. A method as in claim 2, wherein the on-line auction is conducted over a predetermined period of time.

7. A method as in claim 2, wherein the on-line is conducted over the earlier of either a predetermined period of time, or a second predetermined period of time after a first bid is submitted.

8. A method as in claim 2, further comprising enabling a member to participate in the on-line auction over a cellular telephone.

9. A method as in claim 1, wherein the registering includes receiving from the new member information necessary to charge a commercial transaction to a credit card.

10. A method as in claim 1, further comprising rewarding the new member when on-line commercial transactions attributable to the new member are valued at an amount exceeding a predetermined value.

11. A method as in claim 10, wherein the new member receives rewards sponsored by an advertiser.

12. A method as in claim 1, further comprising rewarding the new member upon the new member participating in a predetermined number of on-line commercial transactions.

13. A method as in claim 1, further comprising, when the new member is registered, receiving a charity designation from the new member that would be used for a subsequent transfer, unless another charity designation is made.

14. A method as in claim 1, further comprising, after the predetermined time, allowing the existing member to withdraw a portion of the amount from the account.

15. A method as in claim 14, wherein the withdrawal is conditioned upon the existing member having participated a predetermined number of on-line commercial transactions during the predetermined time.
